(19) United States
(12) Patent Application Publication
(10) Pub. No.: US 2026/0204889 A1
(43) Pub. Date: Jul. 16, 2026

(54) CONTROL APPARATUS, POWER SUPPLY CONTROL SYSTEM, SETTING VALUE DETERMINATION METHOD, AND PROGRAM

(71) Applicant: NTT, Inc., Tokyo (JP)

(72) Inventors: Naoki HANAOKA, Tokyo (JP); Toru TANAKA, Tokyo (JP); Yuji HIGUCHI, Tokyo (JP); Naomichi NAKAMURA, Tokyo (JP)

(73) Assignee: NTT, Inc., Tokyo (JP)

(21) Appl. No.: 19/128,978

(22) PCT Filed: Nov. 14, 2022
(86) PCT No.: PCT/JP2022/042277

§ 371 Date: May 9, 2025

(51) Int. Cl. H02H 3/00; H02H 3/033; H02J 13/36

(52) U.S. Cl. CPC H02H 3/006; H02H 3/033; H02J 13/36

(57) ABSTRACT

A control apparatus for determining a setting value for a plurality of circuit breaker devices in a power feeding system is disclosed. The control apparatus includes a memory; and a processor configured to execute a process. The process includes acquiring a measurement result of a current from each of the circuit breaker devices; and determining a layer to which a corresponding one of the circuit breaker devices belongs based on connection configuration information of the plurality of circuit breaker devices and the measurement result, and determining a setting value of the corresponding one of the circuit breaker devices based on the layer to which the corresponding one of the circuit breaker devices belongs.

### TECHNICAL FIELD

The present invention relates to protection coordination of a power feeding system.

### BACKGROUND ART

In general, in a power feeding system, by appropriately setting setting values such as sensitivity and operation time of a circuit breaker, protection cooperation is taken to quickly separate a fault portion and protect other sound circuits when a fault occurs.

For example, if a short circuit occurs in a power line portion near a load connected to an end of the power feeding system, a very large short circuit current usually flows through the power line, so that the circuit breaker operates instantaneously and the short circuit location is disconnected from the power source.

On the other hand, in recent years, introduction of a loop power feeding system has been promoted in various places (for example, Non Patent Literature 1). The loop power feeding system is a power feeding system in which various power sources (solar power generation (PV) and the like), storage batteries, electric vehicles (EV) and the like are connected in a loop shape by power lines. In such a power feeding system, protection cooperation is achieved by “cascade cut-off” using a plurality of circuit breakers. The cascade cut-off is a mechanism for setting circuit breakers to cut off in order from a lower (load side) facility in an electric system in which a fault has occurred, and suppressing a power failure range as small as possible.

### CITATION LIST

### Non Patent Literature

Non Patent Literature 1: Organizing opinions of issues and the like for construction of a regional microgrid and implementation of a power distribution business (Ministry of Economy, Trade and Industry) https://www.meti.go.jp/shingikai/energy_environment/energy resource/pdf/015_04_00.pdf (searched on Oct. 11, 2022)

### PATENT LITERATURE

Patent Literature 1: JP 2012-49616 A

### SUMMARY OF INVENTION

### Technical Problem

As described above, a storage battery is generally connected to a loop power feeding system. However, since the storage battery becomes a higher order (power source) at the time of discharging and becomes a lower order (load) at the time of charging, the direction of the current and the flowing route are not uniquely determined in the power feeding system to which the storage battery is connected.

Therefore, in a loop power feeding system to which a storage battery is connected, it is difficult to achieve protection coordination. Such a problem is a problem that can occur not only in the loop power feeding system but also in the entire power feeding system to which the storage battery is connected.

The present invention has been made in view of the above points, and an object thereof is to provide a technology capable of appropriately performing protection coordination in a power feeding system to which a storage battery is connected.

### Solution to Problem

According to the disclosed technology, there is provided a control apparatus for determining a setting value for a plurality of circuit breakers in a power feeding system, the control apparatus including:
an information acquisition unit configured to acquire a measurement result of a current from each of the circuit breakers; and
a calculation unit configured to determine a layer to which a corresponding one of the circuit breakers belongs based on connection configuration information of the plurality of circuit breakers and the measurement result, and determine a setting value of the corresponding one of the circuit breakers based on the layer to which the corresponding one of the circuit breakers belongs.

### Advantageous Effects of Invention

According to the disclosed technology, there is provided a technology capable of appropriately performing protection cooperation in a power feeding system to which a storage battery is connected.

### BRIEF DESCRIPTION OF DRAWINGS

FIG. 1 is a configuration diagram of a star power feeding system.

FIG. 2 is a configuration diagram of a loop power feeding system.

FIG. 3 is a diagram illustrating an overall configuration example of a power supply control system.

FIG. 4 is a functional configuration diagram of a control apparatus 100.

FIG. 5 is a diagram illustrating a hardware configuration example of the control apparatus 100.

FIG. 6 is a functional configuration diagram of a circuit breaker.

FIG. 7 is a diagram illustrating a detailed configuration example of the circuit breaker.

FIG. 8 is a diagram illustrating a configuration example including two circuit breakers.

FIG. 9 is a flowchart for explaining an operation example of a system.

FIG. 10 is a diagram illustrating a configuration example of a power feeding system.

FIG. 11 is a diagram illustrating a connection configuration example of the circuit breaker.

FIG. 12 is a diagram illustrating a configuration example of a power feeding system.

FIG. 13 is a diagram illustrating a layer configuration example of the circuit breaker.

FIG. 14 is a diagram illustrating a configuration example of a power feeding system.

FIG. 15 is a diagram illustrating a layer configuration example of the circuit breaker.

FIG. 16 is a diagram illustrating an operation example in a case where cut-off is successful in layer 1.

FIG. 17 is a diagram illustrating an operation example in a case where cut-off fails in the layer 1.

### DESCRIPTION OF EMBODIMENTS

Hereinafter, an embodiment of the present invention (the present embodiment) will be described with reference to the drawings. The embodiment to be described below is merely exemplary, and embodiments to which the present invention is applied are not limited to the following embodiment.

In the embodiment described below, an example in which the technology according to the present invention is applied to a loop power feeding system will be described, but the application destination of the technology according to the present invention is not limited to the loop power feeding system. For example, the technology according to the present invention can also be applied to a mesh power feeding system.

Further, the power feeding system described below is a DC power feeding system, but the application destination of the technology according to the present invention is not limited to the DC power feeding system.

### (Regarding Problems)

Conventional power feeding systems include, for example, a star power feeding system and a loop power feeding system. Star power feeding systems are mainly used for power feeding indoors. Loop power feeding systems are used not only for indoor power feeding but also for power feeding to outdoor devices such as EVs.

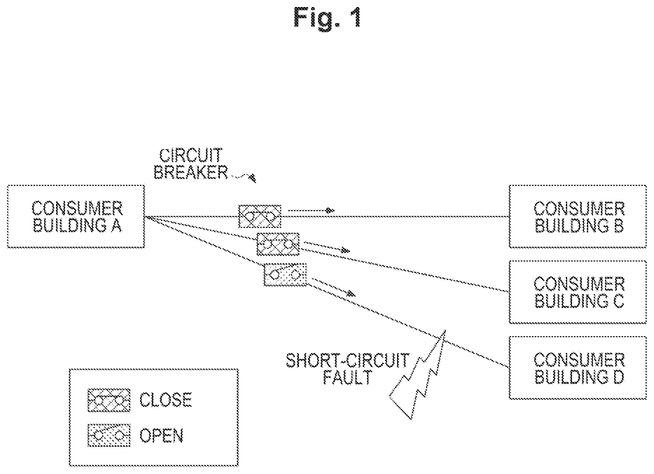

FIG. 1 illustrates a configuration example of a star power feeding system. The power feeding system illustrated in FIG. 1 is a power feeding system that feeds power in one direction from a consumer building A to a consumer building B, a consumer building C, and a consumer building D.

As illustrated in FIG. 1, in this power feeding system, a circuit breaker is installed in each system. As a result, when a short-circuit fault occurs in a certain system, only the circuit breaker of the fault system can be opened, and the short-circuit point can be separated from the electrical circuit. In the example of FIG. 1, an example of a case where a short-circuit fault occurs in a system to which the consumer building D is connected is illustrated. In this mechanism, there is no need for protection coordination. As the circuit breaker, for example, a fuse, a circuit breaker (CB), a direct current circuit breaker, or the like can be used. Examples of the DC circuit breaker include a mechanical circuit breaker, a semiconductor circuit breaker (also referred to as a semiconductor circuit breaker), and a hybrid circuit breaker that is a hybrid of a mechanical circuit breaker and a semiconductor circuit breaker.

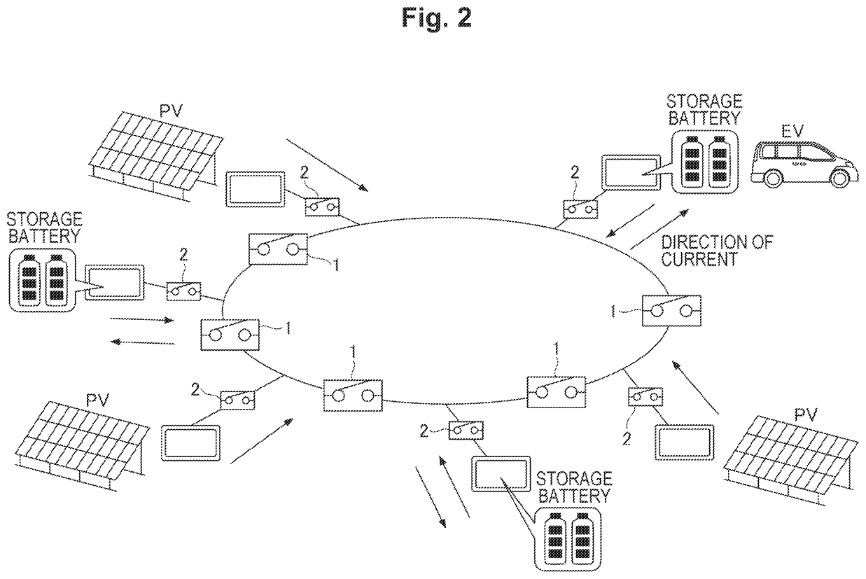

FIG. 2 illustrates a configuration example of a loop power feeding system. As illustrated in FIG. 2, this loop power feeding system is a power feeding system in which various power sources (solar power generation (PV) and the like), storage batteries, electric vehicles (EV) and the like are connected in a loop shape by power lines.

This power feeding system includes a plurality of circuit breakers. Protection coordination is achieved by a “cascade cut-off” including a plurality of circuit breakers. As described above, the cascade cut-off is a mechanism for setting circuit breakers to cut off in order from a lower order (load side) facility in an electric system in which a fault has occurred, and suppressing a power failure range as small as possible. In the cascade cut-off, the circuit breaker connected in the lower order needs to cut off the current faster (in a shorter time from the occurrence of the fault) than the circuit breaker connected in the higher order.

In the conventional technology, in FIG. 2, it is conceivable to set a setting value (for example, a current value, a time limit (operation time), and the like) to the circuit breaker 1 of the higher order and the circuit breaker 2 of the lower order such that the circuit breaker 2 of the lower order breaks before the circuit breaker 1 op the higher order by the higher order/lower order classification based only on the arrangement of the circuit breaker on the power feeding system.

However, since the storage battery generally connected to a loop power feeding system becomes a higher level (power source) at the time of discharging and becomes a lower level (load) at the time of charging, the direction of the current and the flowing route are not uniquely determined in the power feeding system to which the storage battery is connected. Therefore, it is difficult to set the setting value of the circuit breaker based on the idea of “cascade cut-off” at the time of design to achieve protection coordination.

Hereinafter, a configuration and operation of a system for solving the above problem will be described.

### (System Configuration and Outline of Operation)

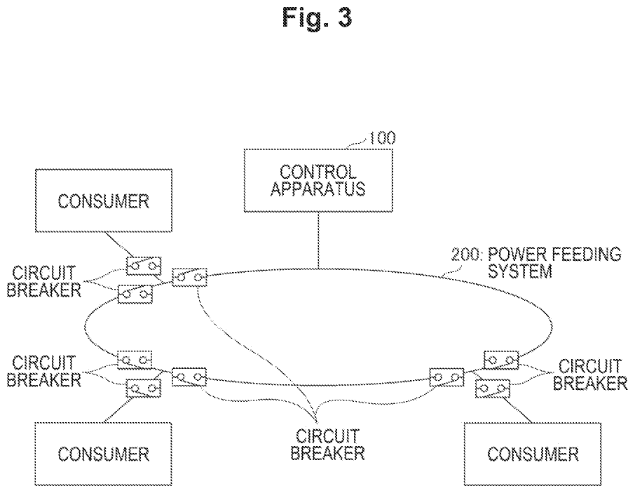

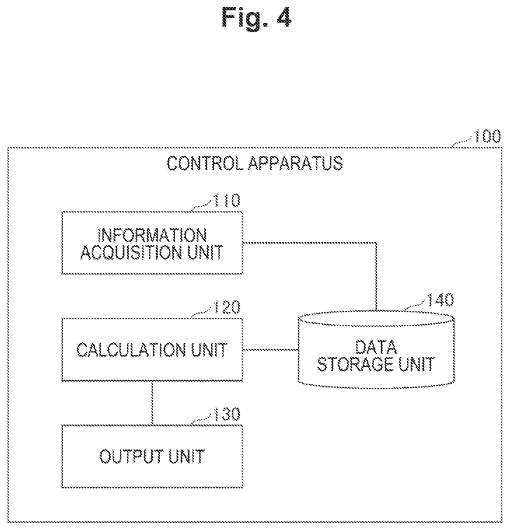

FIG. 3 illustrates a configuration example of a power supply control system in the present embodiment. As illustrated in FIG. 4, the power supply control system in the present embodiment includes a power feeding system 200 and a control apparatus 100.

The power feeding system 200 has a configuration in which each consumer is connected to a loop-shaped power line by a power line. Hereinafter, the loop-shaped power line may be referred to as a “bus”, and the power line connecting the consumer and the bus may be referred to as a “branch wire”. Each consumer may be any one of a load, a storage battery, a power generator using renewable energy, an electric vehicle (EV), and the like. However, in the present embodiment, it is assumed that at least one of the plurality of consumers is a storage battery.

In the present embodiment, three circuit breakers are provided near the branch point of the power line. In the example of FIG. 3, one circuit breaker is provided on a branch wire connecting the branch point and the consumer, and two circuit breakers are provided on the bus across the branch point. However, such arrangement is an example. For example, there may be a case where a circuit breaker is not arranged on a branch wire to which a consumer that is reliably not on the load side (current inflow destination side) is connected.

Each circuit breaker in the present embodiment can cut off a current in any of two directions of a current flowing through the circuit breaker. Each circuit breaker has a communication function and can remotely set/control setting values such as time limits and detected current values.

Each circuit breaker and the control apparatus 100 are connected by a communication network (metal wire, optical fiber, radio wave, or the like), and the control apparatus 100 can acquire information (example: an identification ID and a current direction) necessary for calculation from each circuit breaker.

In the present embodiment, the circuit breakers are also connected to each other via a communication network and can communicate with each other. However, this is an example, and the circuit breakers may not be able to communicate with each other.

From the acquired information, the control apparatus 100 creates a graph with the circuit breaker as a node and the connection between two adjacent circuit breakers as sides based on, for example, graph theory, and adds information on the current flowing through the circuit breaker to the graph.

Information on connection between the circuit breakers may be referred to as connection configuration information. The above graph is an example of the connection configuration information. In addition, information on two adjacent circuit breakers (information on which and which are adjacent) as described later is also an example of the connection configuration information.

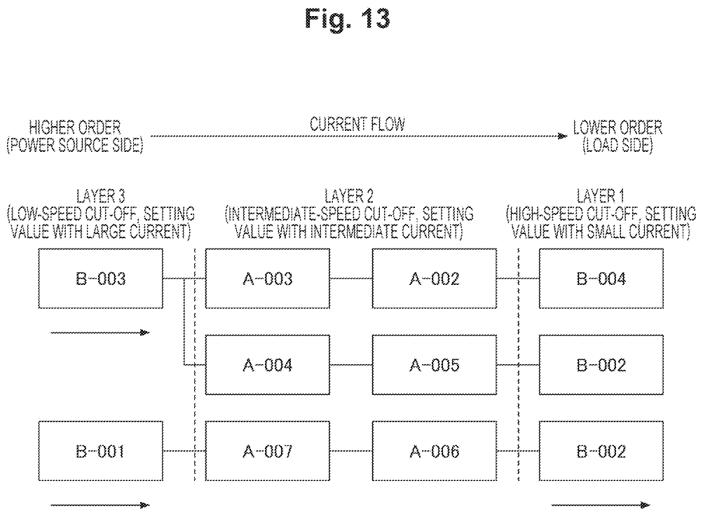

The control apparatus 100 creates a graph in the power feeding system (for example, FIG. 13) and determines a route of the current. Further, the control apparatus 100 sets layers of each circuit breaker based on the concept of “cascade cut-off” and allocates a setting value of the circuit breaker for each layer.

The control apparatus 100 transmits a setting value to each circuit breaker, and each circuit breaker sets the setting value. The control apparatus 100 repeats the above processing at regular time intervals.

(Configuration Example of Control apparatus 100)

FIG. 4 illustrates a configuration example of the control apparatus 100 according to the present embodiment. As illustrated in FIG. 4, the control apparatus 100 includes an information acquisition unit 110, a calculation unit 120, an output unit 130, and a data storage unit 140. Operations of the control apparatus 100 including these functional units will be described later.

The control apparatus 100 can be implemented by, for example, causing a computer to execute a program. This computer may be a physical computer or may be a virtual machine on a cloud.

Specifically, the control apparatus 100 can be implemented by executing a program corresponding to processing to be performed in the control apparatus 100 using hardware resources such as a central processing unit (CPU) and a memory installed in the computer. The above program is recorded in a computer-readable recording medium (such as a portable memory) so that the program can be stored and distributed. Furthermore, the above program can also be provided through a network such as the Internet or an electronic mail.

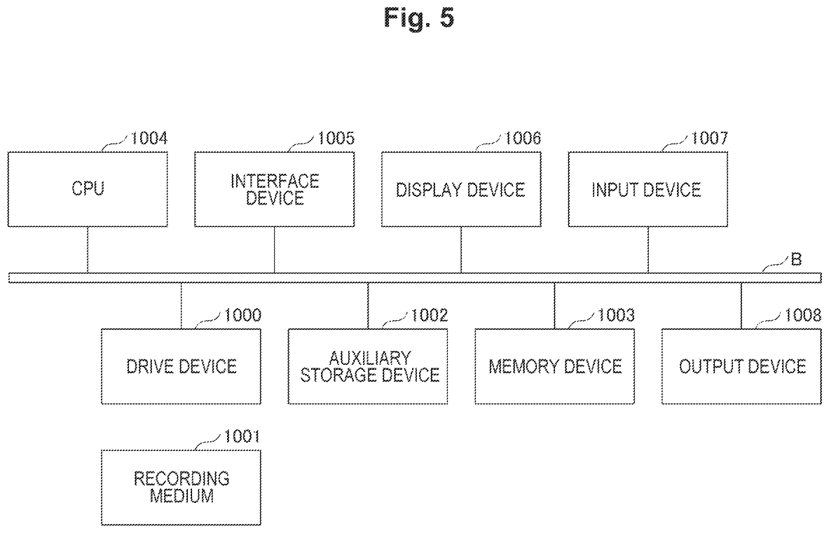

FIG. 5 shows a hardware configuration example of the above computer. The computer in FIG. 5 includes a drive device 1000, an auxiliary storage device 1002, a memory device 1003, a CPU 1004, an interface device 1005, a display device 1006, an input device 1007, an output device 1008, and the like, which are connected to each other by a bus BS. The computer may further include a GPU.

The program for implementing the processing in the computer is provided by a recording medium 1001 such as a CD-ROM or a memory card. When the recording medium 1001 storing the program is set in the drive device 1000, the program is installed from the recording medium 1001 to the auxiliary storage device 1002 via the drive device 1000. However, the program is not necessarily installed from the recording medium 1001 and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002 and stores the program. The CPU 1004 implements a function related to the control apparatus 100 in accordance with the program stored in the memory device 1003. The interface device 1005 is used as an interface for connection to a network or the like. The display device 1006 displays a graphical user interface (GUI) or the like according to the program. The input device 1007 includes a keyboard and a mouse, a button, a touchscreen, and the like and is used to input various operation instructions. The output device 1008 outputs a calculation result.

### (Configuration Example of Circuit Breaker)

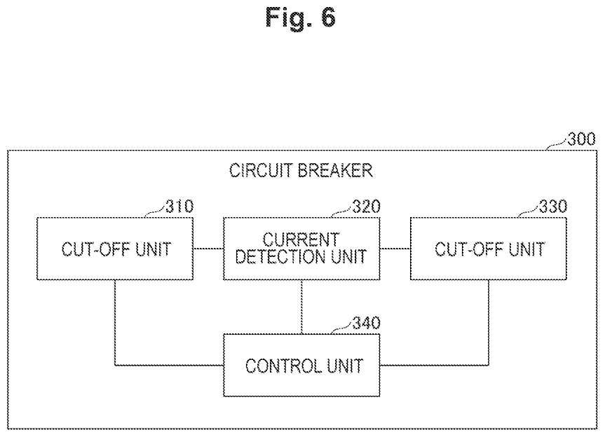

FIG. 6 illustrates a configuration example of a circuit breaker 300 in the present embodiment. As illustrated in FIG. 6, the circuit breaker 300 according to the present embodiment includes a cut-off unit 310, a current detection unit 320, a cut-off unit 330, and a control unit 340. Both the cut-off units 310 and 330 turn on/off (open/cut off) the current according to a control signal from the control unit 340 based on the current detected using the current detection unit 320. The “circuit breaker” may be referred to as a “circuit breaker device”.

The cut-off unit 310 cuts off a current in one direction, and the cut-off unit 330 cuts off a current in one direction opposite to the one direction. The control unit 340 is connected to the control apparatus 100 via a communication network, and performs transmission of a current measurement result, reception and setting of a setting value, and the like. The control unit 340 transmits a control signal instructing cut-off to the cut-off unit 310/cut-off unit 330 based on the current value detected by the current detection unit 320 and the set setting value.

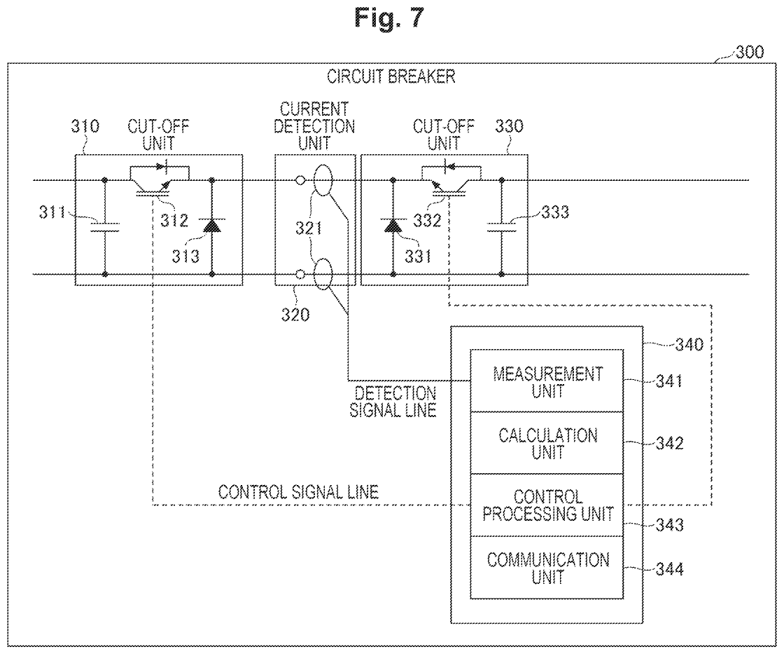

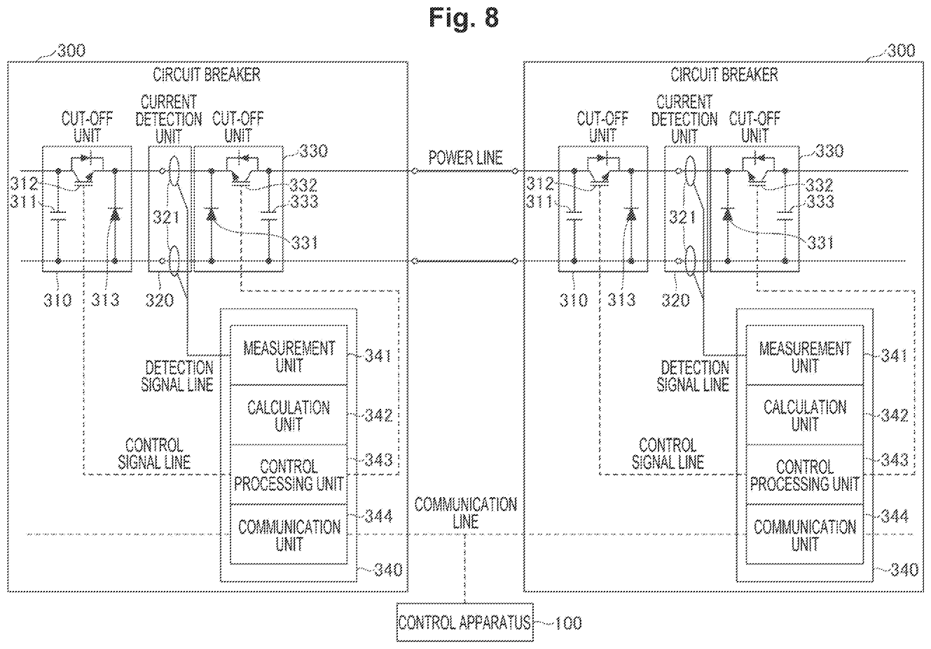

FIG. 7 illustrates a specific configuration example of the circuit breaker 300. In the example of FIG. 8, the cut-off unit 310 includes capacitor 311, transistor 312, and diode 313. The current detection unit 320 includes a current sensor 321. The cut-off unit 330 includes a diode 331, a transistor 332, and a capacitor 333.

The transistors 312, 332 are, for example, MOSFETs. The current sensor 321 is, for example, a Hall element, a shunt resistor, or the like. The use of capacitors/diodes in the parts indicated at 311, 313, 331, and 333 is an example.

The control unit 340 includes a measurement unit 341, a calculation unit 342, a control processing unit 343, and a communication unit 344. All of the measurement unit 341, the calculation unit 342, the control processing unit 343, and the communication unit 344 may be achieved by a hardware circuit, or may be achieved by causing a computer including a CPU and a memory to execute a program.

The measurement unit 341 measures a current value based on the signal obtained from the current detection unit 320. For example, the calculation unit 342 determines whether to transmit a control signal instructing cut-off to the cut-off unit 310/the cut-off unit 330 based on the current value and the setting value. The control processing unit 343 transmits a control signal to the cut-off unit 310/cut-off unit 330. The communication unit 344 performs communication with the control apparatus 100, communication between circuit breakers, and the like.

FIG. 8 illustrates a configuration example in a case where two circuit breakers 300 are connected by a power line.

### (Operation Example)

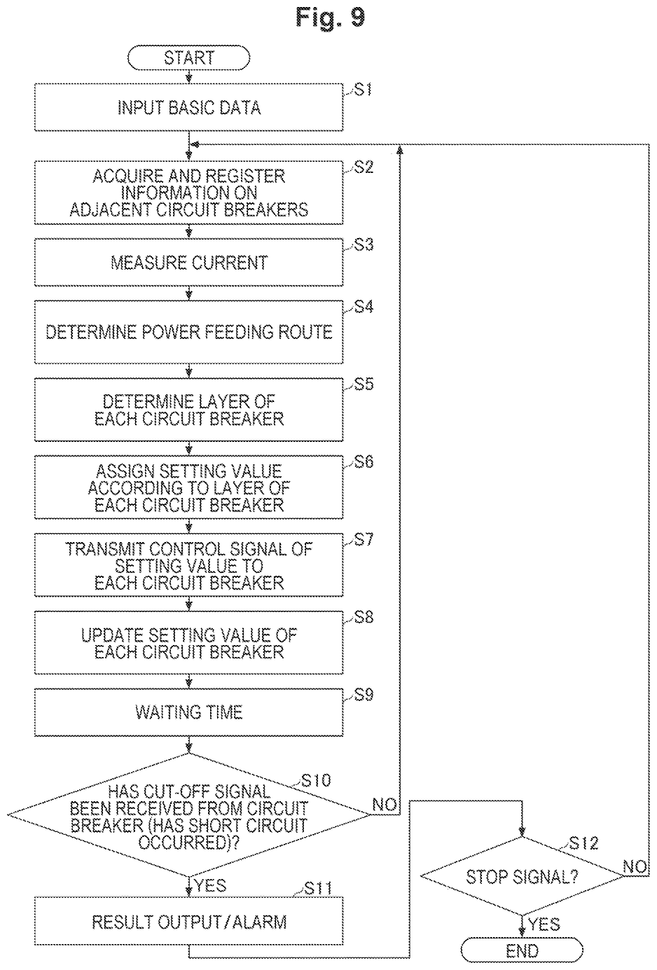

Next, a specific operation example of the system will be described along the procedure of the flowchart of FIG. 9.

### <S1 (Step 1): Basic Data Input>

In S1, basic data necessary for the subsequent calculation is input from the information acquisition unit 110 of the control apparatus 100. The basic data is stored in the data storage unit 140. The basic data is, for example, a unique ID of a circuit breaker, the number of layers, a setting value (parameter) of each layer, a waiting time, and the like.

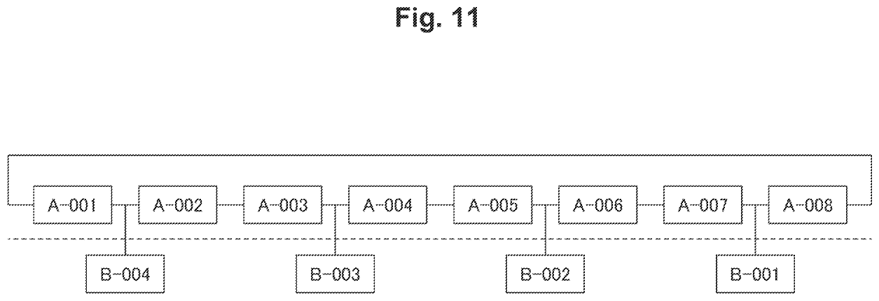

In S1, the connection configuration information (for example, FIG. 11) of the circuit breaker may be manually input as the basic data from the information acquisition unit 110.

### <S2: Acquisition and Registration of Information on Adjacent Circuit Breakers>

In S2, the information acquisition unit 110 acquires information on two adjacent circuit breakers in the target power feeding system, and registers the acquired information in the data storage unit 140. Two adjacent circuit breakers are two circuit breakers in which no other circuit breaker is present on a power line (which may have a branch point) connecting the two circuit breakers. Specific examples will be described below.

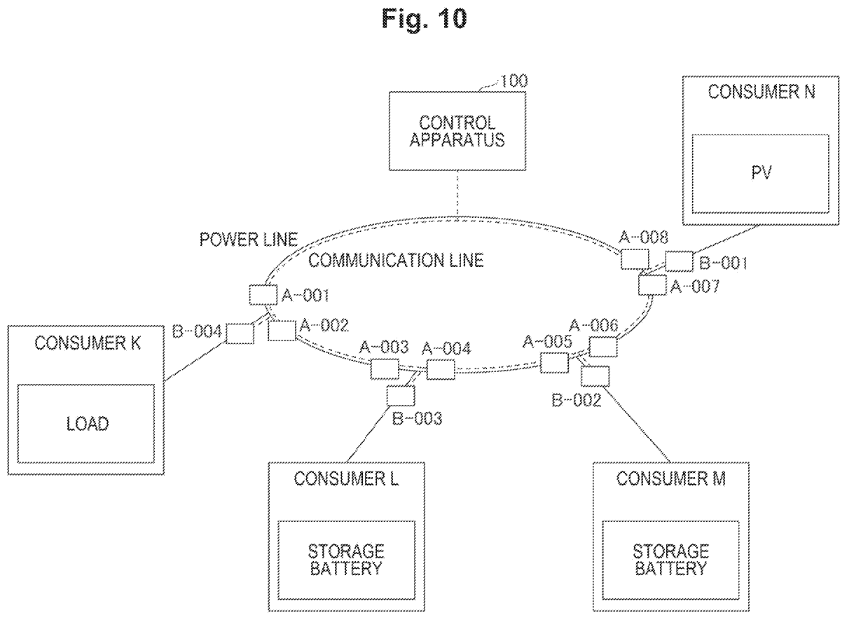

FIG. 10 illustrates an example of a power feeding system as a target in this operation example. As illustrated in FIG. 10, the power feeding system has a configuration in which consumers K to N are connected to a loop-shaped power line (bus) by power lines (branch wires). As illustrated in the drawing, a plurality of circuit breakers are provided, and communication between the circuit breakers and between each circuit breaker and the control apparatus 100 can be performed by a communication line.

It is assumed that a circuit breaker ID is preset in each circuit breaker. Note that “the circuit breaker ID is set in the circuit breaker” may mean that the circuit breaker itself holds the circuit breaker ID, or that the circuit breaker has a unique number (device number or the like) and the control apparatus 100 has correspondence information between the number and the circuit breaker ID.

When the circuit breaker itself holds the circuit breaker ID and the control apparatus 100 side has not yet grasped the circuit breaker ID, the control apparatus 100 may collect the circuit breaker ID from each circuit breaker via the communication line.

In the example of FIG. 10, as illustrated, A-001, A002, . . . , and the like are set as the circuit breaker ID for each circuit breaker. In this example, a character string obtained by connecting the layer information (A, B, . . . ) on the arrangement of the circuit breaker and the identification number (001, 002, . . . ) of each circuit breaker with a hyphen is set as the circuit breaker ID. Here, as the layer information on the arrangement, the layer information of the circuit breaker on the bus is “A”, and the layer information of the circuit breaker on the branch wire is “B”.

In S2, the information acquisition unit 110 recognizes which two adjacent circuit breakers are, for example, by transmitting and receiving signals (packets) between the circuit breakers and acquiring information on a result of the transmission and reception, and stores the recognized information in the data storage unit 140. Alternatively, the information of the adjacent circuit breaker may be manually input from the information acquisition unit 110. FIG. 11 illustrates the connection configuration information (graph in which a circuit breaker is a node and a portion between adjacent circuit breakers is a side) of the circuit breaker that can be constructed from the information of the adjacent circuit breakers.

### <S3: Current Measurement>

In S3, the current detection unit 320 and the control unit 340 of each circuit breaker measure the direction of the current passing through the circuit breaker and the magnitude of the current. “The direction of the current and the magnitude of the current” may be referred to as a current value. The direction of the current can be determined based on whether the current value is positive or negative. From the viewpoint of determining the setting value, only the direction of the current may be measured and acquired in S3.

The information acquisition unit 110 of the control apparatus 100 acquires a measurement result from the control unit 340 of each circuit breaker and stores the measurement result in the data storage unit 140. By this current measurement, the data storage unit 140 stores the circuit breaker ID, the direction of the current, and the magnitude of the current for each circuit breaker ID.

### <S4: Determination of Power Feeding Route, S5: Determination of Layer of Each Circuit Breaker>

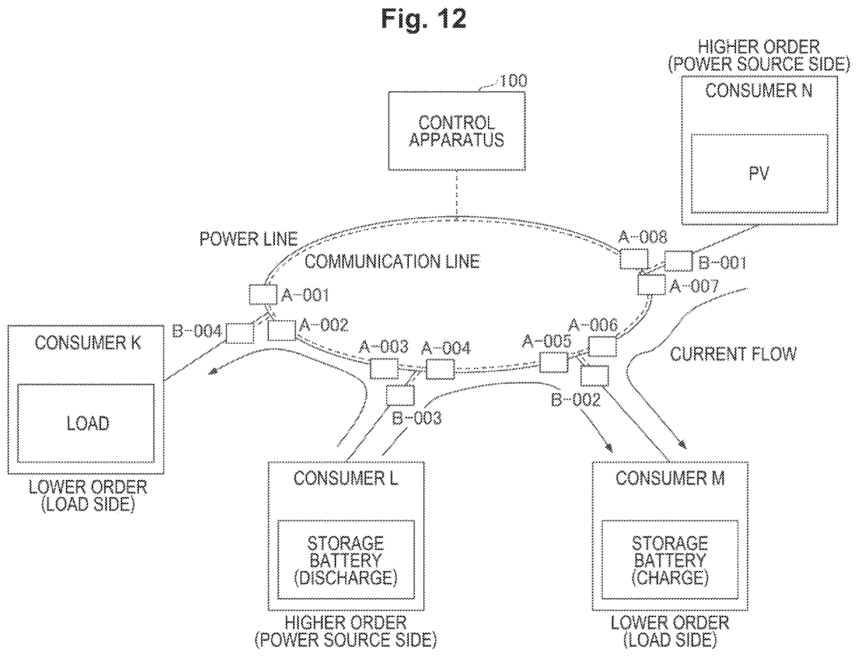

In S4, the calculation unit 120 of the control apparatus 100 determines the power feeding route based on the connection configuration information of the circuit breaker and the data obtained by the current measurement. In S5, the calculation unit 120 determines the layer of each circuit breaker based on the power feeding route. A specific example here will be described with reference to FIGS. 12 to 15.

It is assumed that the calculation unit 120 determines a power feeding route in which a current flows from the consumer N to the consumer M and a current flows from the consumer L to each of the consumer K and the consumer M as illustrated in FIG. 12 based on the connection configuration information of the circuit breaker and the measurement result of the current in each circuit breaker.

From the viewpoint of the flow of the current, the calculation unit 120 classifies each circuit breaker into a layer with the power source side (current outflow source side) as the higher-order side and the load side (current inflow destination side) as the lower-order side. Here, it is assumed that the higher the numerical value of the layer, the higher the order of the layer.

In the case of the current flow illustrated in FIG. 12, the calculation unit 120 divides each circuit breaker into layers such as “Layer 3: B-003, B-001, Layer 2: A-002 to A-006, Layer 1: B-002, B-004” as illustrated in FIG. 13. In this example, the number of layers is three, but the number of layers is not limited to three.

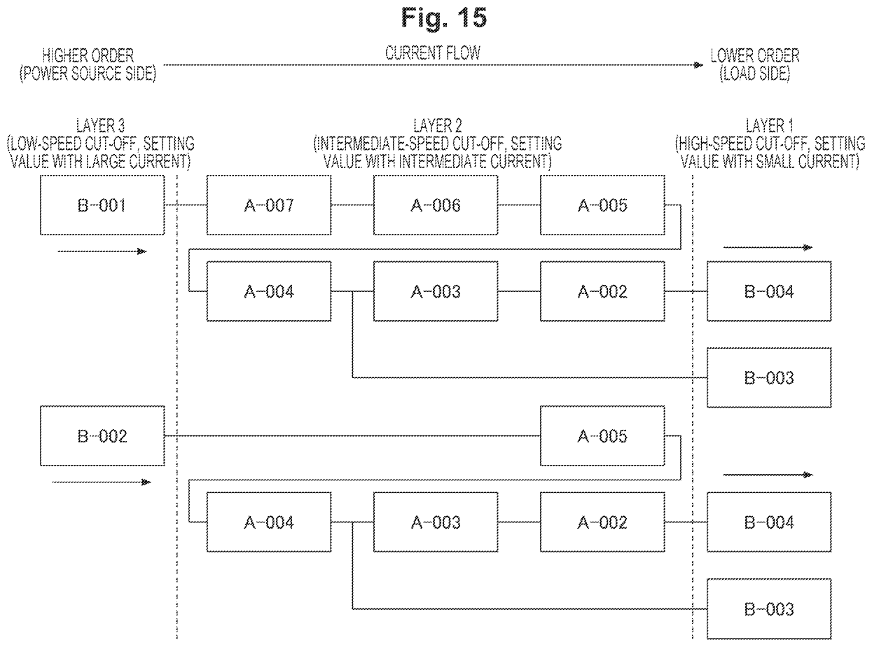

FIG. 13 (and FIG. 15) also illustrates an example of a setting policy of a setting value to be described later. That is, as illustrated in FIG. 13, the setting value of each circuit breaker (example: the current value for operating the circuit breaker) is set such that the circuit breaker in the lower-order layer cuts off the current faster than the circuit breaker in the higher-order layer.

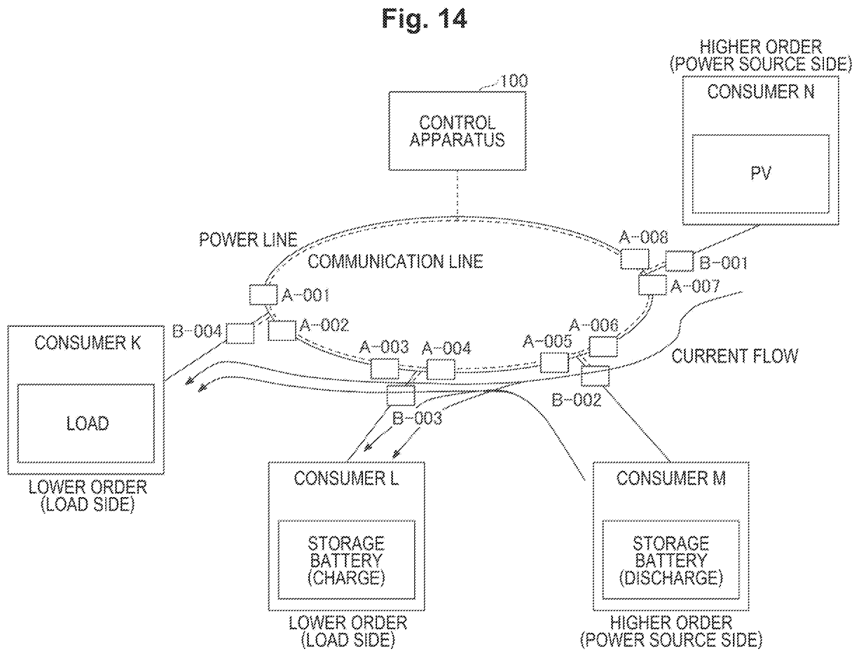

Another example will be described with reference to FIGS. 14 and 15. It is assumed that the calculation unit 120 determines a power feeding route in which a current flows from the consumer N to each of the consumer K and the consumer L and a current flows from the consumer M to each of the consumer K and the consumer L as illustrated in FIG. 14 based on the connection configuration information of the circuit breaker and the measurement result of the current in each circuit breaker.

In this case, the calculation unit 120 divides each circuit breaker into layers such as “Layer 3: B-001, B-002, Layer 2: A-002 to A-007, Layer 1: B-003, B-004” as illustrated in FIG. 15.

### <S6: Assignment of Setting Value According to Layer of Each Circuit Breaker>

In S6, the calculation unit 120 of the control apparatus 100 determines the setting value of each circuit breaker based on the layer of each circuit breaker determined in S5.

Specifically, for example, when a circuit breaker (which may be referred to as a semiconductor circuit breaker) as illustrated in FIG. 7 is used, the calculation unit 120 determines the detected current (which may be referred to as a cut-off current) as a low value (example: 30 A) for the circuit breaker classified as layer 1. When the detection current of the circuit breaker is 30 A, the circuit breaker cuts off the current when detecting a current having a magnitude of 30 A or more (current flowing to the load side).

For a circuit breaker classified as layer 2, the detection current is determined as an intermediate value (for example, 35 A). For a circuit breaker classified as layer 3, the detection current is determined as a high value (for example, 40 A).

### <S7 to S12>

In S7, the output unit 130 transmits a control signal for instructing each circuit breaker to set a setting value. The control apparatus 100 may perform processing up to determination of the setting value, and processing such as transmission of a control signal of the setting value may be performed by a device different from the control apparatus 100. In addition, the determined setting value may be notified to each consumer by any communication means, and the setting value may be manually set to the circuit breaker in the side of each consumer.

In S8, the control unit 340 of each circuit breaker receives the setting value and updates the setting value in the circuit breaker. In S9, the control apparatus 100 waits for a predetermined standby time.

When the information acquisition unit 110 receives the cut-off signal (example: a short circuit occurrence notification signal) from any one of the circuit breakers during the standby time in S10, the process proceeds to S11. When the cut-off signal is not received from any of the circuit breakers during the standby time, the process returns to S2.

In S11, the output unit 130 outputs, for example, a result of cut-off (information of a cut-off layer or the like), an alarm, and the like. When the information acquisition unit 110 receives the stop signal in S12, the process ends, and when the information acquisition unit 110 does not receive the stop signal, the process returns to S2. The stop signal may be transmitted from a terminal from a system administrator or may be transmitted from another system.

As described above, the processing of the flow illustrated in FIG. 9 is performed.

The circuit breaker used in the present embodiment is not limited to the semiconductor circuit breaker illustrated in FIG. 8. For example, a circuit breaker that performs cut-off based on a signal from an overcurrent relay (OCR) may be used. In this case, the “an overcurrent relay and a circuit breaker that performs cut-off based on a signal from the overcurrent relay” can be used as a circuit breaker included in the power feeding system in the present embodiment.

Even when the overcurrent relay is used as described above, the method for determining the setting value (tap value, lever position, and the like) is basically the same as the method described above, and the setting value of the overcurrent relay of the higher-order layer and the setting value of the overcurrent relay of the lower-order layer are determined such that the circuit breaker of the lower-order layer cuts off the current faster (in a shorter time) than the circuit breaker of the higher-order layer.

### (Example of Cut-Off)

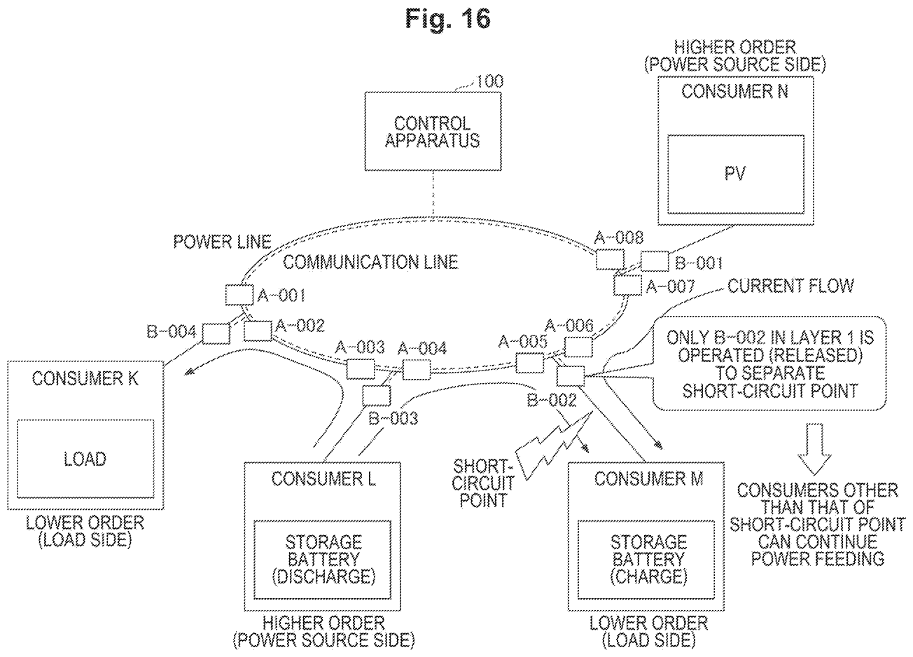

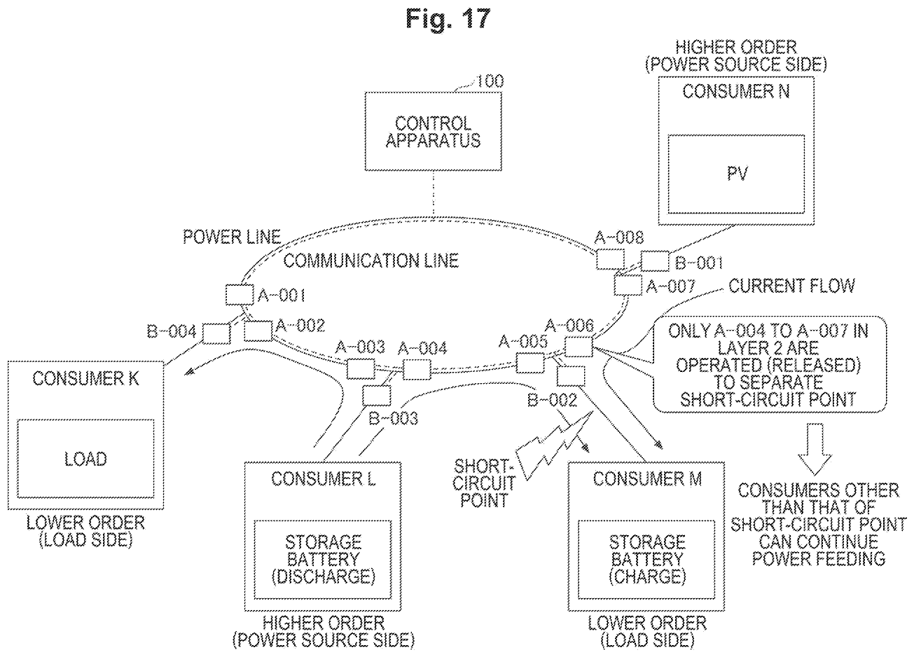

In the examples of FIGS. 12 and 13 described above, an example of cut-off when a short circuit occurs in a branch wire connected to the consumer M will be described with reference to FIGS. 16 and 17. In both cases of FIGS. 16 and 17, the layer configuration is as illustrated in FIG. 13.

FIG. 16 illustrates an operation in a case where cut-off is successful in the layer 1. In this case, only the circuit breaker of B-002 in the layer 1 is opened to separate the short-circuit point. Power feeding to consumers connected to branch wires other than the branch wire where the short-circuit point has occurred is continued.

FIG. 17 illustrates an operation in a case where cut-off fails in the layer 1. In this case, only the circuit breaker of A-004 to A-007 in the layer 2 is opened to separate the short-circuit point. Even in this case, power feeding to consumers connected to branch wires other than the branch wire where the short-circuit point has occurred is continued.

### Summary of Embodiment, Effects, and Like

As described above, according to the technology described in the present embodiment, it is possible to appropriately perform protection coordination in the power feeding system to which the storage battery is connected.

Specifically, for example, by connecting a storage battery to a power feeding system in which a plurality of systems are complicatedly branched, such as a loop or mesh power feeding system, even in a case where a route or a direction of a current changes every moment, it is possible to flexibly perform protection cooperation by automatically and appropriately controlling a setting value of a circuit breaker for each layer in accordance with a power flow. Regarding the above embodiment, the following clauses are further disclosed.

### CLAUSES

### (Clause 1)

A control apparatus for determining a setting value for a plurality of circuit breaker devices in a power feeding system, the control apparatus including:
a memory; and
at least one processor connected to the memory
in which the processor is configured to
acquire a measurement result of a current from each of the circuit breaker devices and
determine a layer to which a corresponding one of the circuit breaker devices belongs based on connection configuration information of the plurality of circuit breaker devices and the measurement result, and determine a setting value of the corresponding one of the circuit breaker devices based on the layer to which the corresponding one of the circuit breaker devices belongs.

### (Clause 2)

The control apparatus according to clause 1, in which the processor determines a route of a current passing through the circuit breaker devices based on the connection configuration information of the plurality of circuit breaker devices and the measurement result, determines a layer of the circuit breaker devices on a current outflow source side as a higher-order layer, and determines a layer of the circuit breaker devices on a current inflow destination side as a lower-order layer.

### (Clause 3)

The control apparatus according to clause 2, in which the processor determines the setting value of the circuit breaker devices of the higher-order layer and a setting value of a circuit breaker devices of the lower-order layer such that the circuit breaker devices of the lower-order layer cut off a current faster than the circuit breaker devices of the higher-order layer.

### (Clause 4)

A power supply control system including: the control apparatus according to any one of clauses 1 to 3; and the power feeding system.

### (Clause 5)

A setting value determination method of determining a setting value for a plurality of circuit breaker devices in a power feeding system, the setting value determination method including:
an information acquisition step of acquiring a measurement result of a current from each of the circuit breaker devices; and
a calculation step of determining a layer to which a corresponding one of the circuit breaker devices belongs based on connection configuration information of the plurality of circuit breaker devices and the measurement result, and determining a setting value of the corresponding one of the circuit breaker devices based on the layer to which the corresponding one of the circuit breaker devices belongs.

### (Clause 6)

A non-transitory computer-readable storage medium storing a program for causing a computer to function as each unit in the control apparatus according to any one of clauses 1 to 3.

Although the present embodiment has been described above, the present invention is not limited to such a specific embodiment, and various modifications and changes can be made within the scope of the concept of the present invention disclosed in the claims.

### REFERENCE SIGNS LIST

100 Control apparatus
110 Information acquisition unit
120 Calculation unit
130 Output unit
140 Data storage unit
200 Power feeding system
300 Circuit breaker
310 Cut-off unit
311 Capacitor
312 Transistor
313 Diode
320 Current detection unit
321 Current sensor
330 Cut-off unit
331 Diode
332 Transistor
333 Capacitor
340 Control unit
341 Measurement unit
342 Calculation unit
343 Control processing unit
344 Communication unit
1000 Drive device
1001 Recording medium
1002 Auxiliary storage device
1003 Memory device
1004 CPU
1005 Interface device
1006 Display device
1007 Input device
1008 Output device

1. A control apparatus for determining a setting value for a plurality of circuit breaker devices in a power feeding system, the control apparatus comprising:
a memory; and
a processor configured to execute a process, the process including:
acquiring a measurement result of a current from each of the circuit breaker devices; and
determining a layer to which a corresponding one of the circuit breaker devices belongs based on connection configuration information of the plurality of circuit breaker devices and the measurement result, and determining a setting value of the corresponding one of the circuit breaker devices based on the layer to which the corresponding one of the circuit breaker devices belongs.

2. The control apparatus according to claim 1,
wherein the determining includes determining a route of a current passing through the circuit breaker devices based on the connection configuration information of the plurality of circuit breaker devices and the measurement result, determining a layer of the circuit breaker devices on a current outflow source side as a higher-order layer, and determining a layer of the circuit breaker devices on a current inflow destination side as a lower-order layer.

3. The control apparatus according to claim 2,
wherein the determining includes determining the setting value of the circuit breaker devices of the higher-order layer and the setting value of the circuit breaker devices of the lower-order layer such that the circuit breaker devices of the lower-order layer cut off a current faster than the circuit breaker devices of the higher-order layer.

4. A power supply control system comprising:
the control apparatus according to claim 1; and
the power feeding system.

5. A setting value determination method of determining a setting value for a plurality of circuit breaker devices in a power feeding system, the setting value determination method comprising:
acquiring a measurement result of a current from each of the circuit breaker devices; and
determining a layer to which a corresponding one of the circuit breaker devices belongs based on connection configuration information of the plurality of circuit breaker devices and the measurement result, and determining a setting value of the corresponding one of the circuit breaker devices based on the layer to which the corresponding one of the circuit breaker devices belongs.

6. A non-transitory computer-readable recording medium having computer-readable instructions stored thereon, which when executed, cause a computer to function as each unit in the control apparatus according to claim 1.
